(19) United States
(12) Patent Application Publication
(10) Pub. No.: US 2020/0215367 A1
(43) Pub. Date: Jul. 9, 2020

(54) SMALL FIRE EXTINGUISHER EQUIPPED WITH A ROTARY KNOB AT THE TOP

(71) Applicant: LASWELL CO., LTD., Paju-si, Gyeonggi-do (KR)

(72) Inventors: Hyung Ho JOO, Goyang-si (KR); Min Soo HONG, Seoul (KR)

(21) Appl. No.: 16/342,673

(22) PCT Filed: Sep. 10, 2018
(86) PCT No.: PCT/KR2018/010565

§ 371 Date: Apr. 17, 2019

(30) Foreign Application Priority Data
Sep. 29, 2017 (KR) 10-2017-0126951
Mar. 8, 2018 (KR) 10-2018-0027671

(51) Int. Cl. A62C 13/64; A62C 13/76; B05B 12/00; G01L 7/02

(52) U.S. Cl. CPC A62C 13/64; G01L 7/02; B05B 12/0026; A62C 13/76

(57) ABSTRACT

A small fire extinguisher equipped with a rotary knob includes: a body part storing loaded stream; a nozzle part that is attached to the top of the body part and includes a valve at the inner center where compressed the loaded stream is sprayed, and a key insertion part where an L-shaped lock key is inserted or removed; a button part that is inserted and attached to the top of the nozzle part to open and close the valve with the button vertically entering in and coming out of the nozzle part; a plate rotary knob that is attached to one side of the nozzle part, covers up one end of the nozzle part, contacts the top of the button part, and is attached with a lock key; and a lock key which is attached to the plate rotary knob and stops or rotates the plate rotary knob.

### BACKGROUND

### 1. Field of the Invention

This invention relates to a small fire extinguisher that is installed on vehicles or private houses for convenient use. Existing fire extinguishers are furnished in an invisible corridor or corner because they are too large and heavy. Fire extinguishment is delayed as it takes a lot of time to find fire extinguishers when fire actually occurs. Therefore, this invention is intended to make a small fire extinguisher that can be stored in a living room or next to a kitchen sink so it can be used immediately when fire occurs.

### 2. Description of Related Art

The background art related to this invention is presented in KR Patent No. 10-1023513 (published on Mar. 21, 2011). FIG. 1 is a block diagram of the manual switch for the conventional gas hydrant. In FIG. 1, the manual switch for the conventional gas hydrant is comprised of a casing (100) that is sequentially attached with a rotary knob (200) and operating knob (300). The casing (100) is equipped with an attaching groove (150) that is dented inward so that the rotary knob (200) can be attached and rotated. A positioning unit (110) is available to adhere the rotary knob (200) to the inner edge. Also, the positioning unit (110) is comprised of an elastic support that projects from the inside of the casing (100) toward the top. In addition, on the casing (100), a sliding groove (120) inserted with an operating bar (330) below is formed at the center of the knob attaching groove (150). There is a slot (130) on one side of the sliding groove (120). For the rotary knob (200) attached to the casing, there is at least one positioning groove (205) on the inner circumference so that the positioning unit (110) determines the position when it is supported on the inside of the casing. Also, a dented switch attaching hole (230) is formed on the top surface of the rotary knob (200) so as to attach the operating knob (300) below. In addition, a position detection bar (250) that passes through the slot (130) projects out of the bottom of the rotary knob (200). Also, on the switch attaching hole (230), a guide stopper (201) is formed in response to one or more guide grooves (301) formed on the circumference of the operating knob (300). A penetration groove (not illustrated) that is penetrated by the operating bar (330) is formed at the inner center. The operating knob (300) attached to the rotary knob (200) is elastically supported by a fixing piece (not illustrated) supported by the casing (100) by interposing a spring (310) on the switch attaching hole (230). The polygonal operating bar (330) is exposed underneath the casing (100). Also, on the operating knob (300), a guide groove (301) is formed as one body on the circumference of the knob in response to the guide stopper (201). The on/off switch (360) is attached to a substrate (310) in response to the operating bar (330) of the operating knob (300). The substrate (310) is additionally equipped with a status detection switch (350) in response to the positioning bar (250), as well as multiple lamps (370) that are operated by the status detection switch on one side. Also, the status detection switch (350) is attached to the substrate (310) so that it can contact the positioning bar (250) that projects out of the bottom of the rotary knob when the bar is exposed through the slot (130) from on the casing and rotates. On the one hand, a release switch (380) is additionally equipped on one side of the on/off switch (360) to release the on/off switch. The release switch contacts the operating knob (340) on top of it.

### SUMMARY OF THE INVENTION

The manual switch for the conventional gas hydrant described above has complex composition, and there are problems of high manufacturing cost and frequent failure caused by large number of parts. Also, the background art is difficult to be applied to small fire extinguishers injected with loaded stream. Therefore, the object of this invention is to provide a fire extinguisher with simple composition that can be used quickly in case of fire and applied to small fire extinguishers. Another object of this invention is to provide a fire extinguisher whose manufacturing cost is low.

To this end, there is provided a small fire extinguisher equipped with a rotary knob includes a bottle-shaped body part that stores loaded stream sprayed in case of fire, a nozzle part that is attached to the top of the body part, has a valve at the inner center where compressed loaded stream is sprayed through an opening part on one side by pressing a button part, and has a key insertion part where an L-shaped lock key can be inserted or removed on the other side of a round-shaped plate rotary knob attached to one side, a button part that is inserted and attached to the top of the nozzle part so as to open and close the valve with the button vertically entering in and coming out of the nozzle part according to rotation of the plate rotary knob, a plate rotary knob of round cover shape that is attached to one side of the nozzle part by a fixing pin, covers up one end of the nozzle part at a fixed distance, contacts the top of the button part, and is attached with a lock key on the other side that controls rotation of the plate rotary knob, and a lock key that is attached to the plate rotary knob and stops or rotates the plate rotary knob by inserting or removing a key into or from the nozzle part as a key handle is turned clockwise or counterclockwise.

### Advantageous Effects of the Invention

The small fire extinguisher equipped with a rotary knob can prevent loss of the lock key by attaching the lock key to the rotary knob as one body. Also, the small fire extinguisher can be furnished in a vehicle or indoor place because of small size. Also, the small fire extinguisher can be used without a hose in case of fire by using the body part and rotary knob. Accordingly, it takes a low manufacturing cost due to simple composition.

### BRIEF DESCRIPTION OF THE DRAWINGS

FIG. 1 is a block diagram of the manual switch for a conventional gas hydrant.

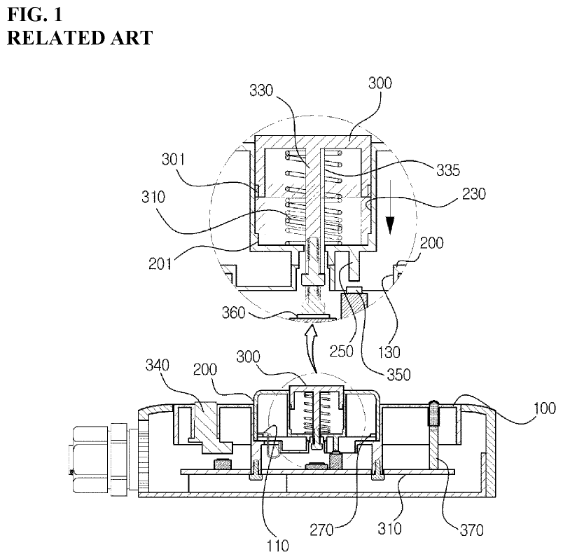

FIG. 2 is a perspective block diagram of the small fire extinguisher of this invention equipped with a rotary knob.

FIG. 3 is a perspective block diagram of the small fire extinguisher of this invention equipped with a rotary knob viewed on another angle.

FIG. 4 is an exploded block diagram of the small fire extinguisher of this invention equipped with a rotary knob.

FIG. 5 is a state diagram of the lock key of this invention inserted into the key insertion part.

FIG. 6 is a state diagram of the lock key of this invention removed from the key insertion part.

FIG. 7 is a locking state diagram of the 2nd embodiment for the small fire extinguisher of this invention equipped with a rotary knob at the top.

FIG. 8 is an unlocking state diagram of the 2nd embodiment for the small fire extinguisher of this invention equipped with a rotary knob at the top.

FIG. 9 is a nozzle open state diagram of the 2nd embodiment for the small fire extinguisher of this invention equipped with a rotary knob at the top.

FIG. 10 is an exploded perspective diagram of the 2nd embodiment for small fire extinguisher of this invention equipped with a rotary knob at the top.

### DETAILED DESCRIPTION OF THE EMBODIMENTS

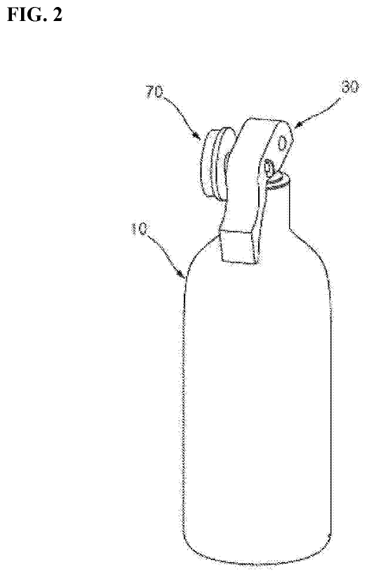

The small fire extinguisher of this invention equipped with a rotary knob with the purpose above can be described using FIGS. 2 through 10 as below.

FIG. 2 is a perspective block diagram of the small fire extinguisher of this invention equipped with a rotary knob. In FIG. 2, the small fire extinguisher of this invention equipped with a rotary knob is comprised of a body part (10) that loads high-pressure loaded stream, a nozzle part (20) attached to the top of the body part, a plate rotary knob (30) attached to the nozzle part, and a pressure gauge (70) attached to the nozzle part that displays current pressure of loaded stream filled inside the body part.

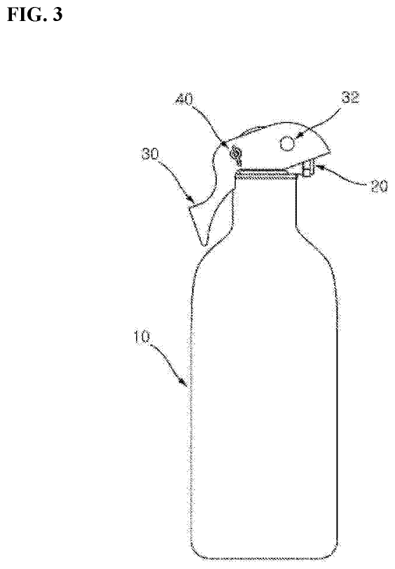

FIG. 3 is a perspective block diagram of the small fire extinguisher of this invention equipped with a rotary knob viewed on another angle. In FIG. 3, the small fire extinguisher of this invention equipped with a rotary knob is comprised of a body part (10) that loads high-pressure loaded stream, a nozzle part (20) attached to the top of the body part that allows loaded stream to be sprayed by opening and closing a valve, a plate rotary knob (30) attached to the nozzle part that opens and closes the valve inside the nozzle part by operating a button part, and a lock key (40) attached to the plate rotary knob.

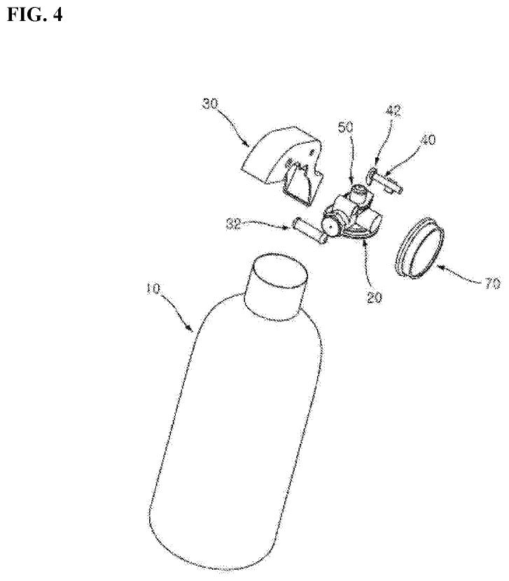

FIG. 4 is an exploded block diagram of the small fire extinguisher of this invention equipped with a rotary knob. In FIG. 4, the small fire extinguisher of this invention equipped with a rotary knob is comprised of a body part (10) that stores loaded stream sprayed during fire, a nozzle part (20) that is attached to the top of the body part, has a valve at the inner center where compressed loaded stream is sprayed through an opening part on one side by pressing a button part, and is comprised of a key insertion part (22) where an L-shaped lock key can be inserted or removed on the other side of a round-shaped plate rotary knob attached to one side, a button part (50) that is inserted and attached to the top of the nozzle part so as to open and close the valve with the button (52) vertically entering in and coming out of the nozzle part according to rotation of the plate rotary knob, a plate rotary knob (30) of round cover shape that is attached to one side of the nozzle part by a fixing pin (32), covers up one end of the nozzle part at a fixed distance, contacts the top of the button part, and is attached with a lock key (40) on the other side that controls rotation of the plate rotary knob, and a lock key (40) attached to the plate rotary knob that stops or rotates the plate rotary knob by inserting or removing a key (44) into or from the nozzle part as a key handle (42) is turned clockwise or counterclockwise. The small fire extinguisher of this invention equipped with a rotary knob comprised of the exhausts loaded stream in the body part (10) through the nozzle by opening the valve inside the nozzle part when the lock key (40) is rotated to detach the key from the key insertion part (22), the plate rotary knob (30) is rotated to one side and presses the button (52) on the button part (50), and the button is inserted into the nozzle part (20).

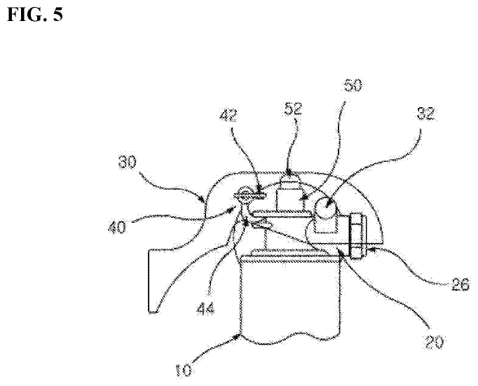

FIG. 5 is a state diagram of the lock key of this invention inserted into the key insertion part. In FIG. 5, the nozzle part (20) is comprised of the key insertion part (22) and the key (44) of the lock key (40) installed on the plate rotary knob (30) is normally inserted into the key insertion part (22) to fix the plate rotary knob (30) so as to prevent rotation. To use the fire extinguisher in case of fire, the plate rotary knob (30) can be rotated by rotating the lock key (40) to one side as the key (44) is detached from the key insertion part (22) of the nozzle part. When the plate rotary knob (30) is rotated as described above, the plate rotary knob (30) presses the button on the button part (50) at the top of the nozzle part to exhaust loaded stream.

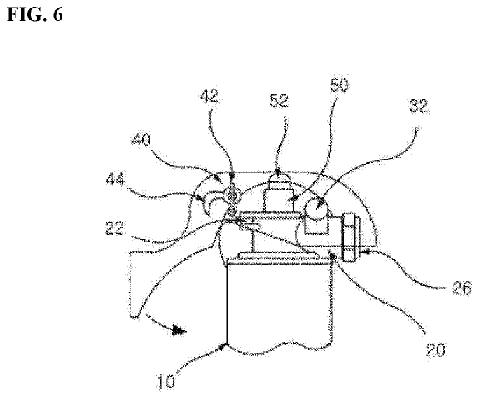

FIG. 6 is a state diagram of the lock key of this invention removed from the key insertion part. In FIG. 6, the plate rotary knob (30) can rotate to one side because the key (44) of the lock key (40) has been detached from the key insertion part (22) that comprises the nozzle part (20) by rotating the key handle (42) of the lock key (40) installed on the plate rotary knob to one side. When the plate rotary knob (30) is rotated to one side, the bottom surface of the plate rotary knob (30) lowers the button by pressing the button (52) on the button part (50) comprised at the top of the nozzle part. When the button is lowered, the valve inside the nozzle part (20) opens to exhaust loaded stream inside the body part (10) to outside through the valve and nozzle (26). Also, the plate rotary knob can be made of a variety of materials including reinforced plastics and aluminum. The drawing also shows that color of the body part can be varied according to preference of the user.

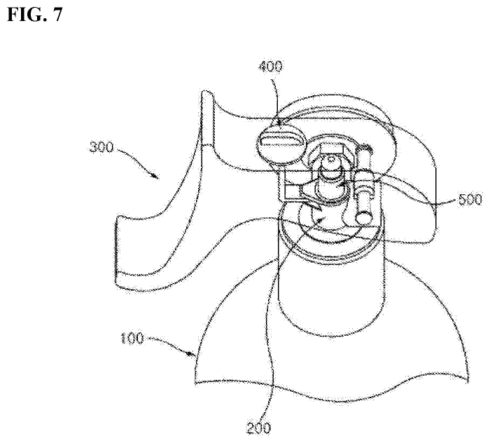

FIG. 7 is a locking state diagram of the 2nd embodiment for the small fire extinguisher of this invention equipped with a rotary knob at the top. In FIG. 7, the 2nd embodiment for the small fire extinguisher of this invention equipped with a rotary knob at the top is comprised of a body part (100) that loads high-pressure extinguishing liquid, a nozzle part (200) attached to the top of the body part, an L-shaped and round plate rotary knob (300) attached to the nozzle part, a locking part (400) comprised at the top of the L-shaped and round plate rotary knob that controls rotation of the plate rotary knob by inserting or removing an L-shaped key into or from the insertion end of the lock key on the nozzle part, and a pressure gauge (700) attached to one side of the nozzle part that displays pressure of extinguishing liquid inside the body part.

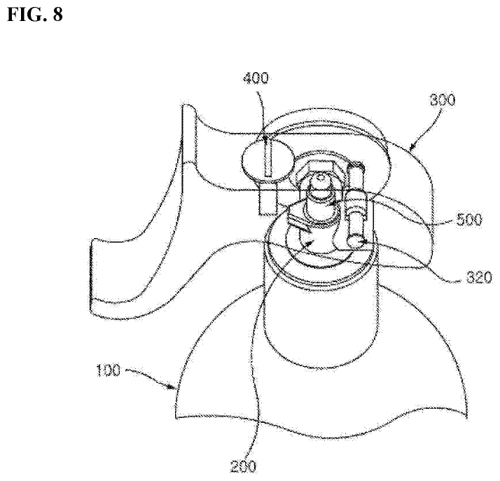

FIG. 8 is an unlocking state diagram of the 2nd embodiment for the small fire extinguisher of this invention equipped with a rotary knob at the top. In FIG. 8, the 2nd embodiment of the small fire extinguisher of this invention equipped with a rotary knob at the top is comprised of a body part (100) that loads high-pressure extinguishing liquid, a nozzle part (200) attached to the top of the body part that sprays extinguishing liquid by opening and closing a valve, an L-shaped and round plate rotary knob (300) attached to the nozzle part (200) that opens and closes the valve inside the nozzle part by operating a button part (500), and a locking part (400) attached to the top of the L-shaped and round plate rotary knob that makes a lock key to be removed from the key insertion part and stay away on one side by rotating the rotary knob (420) clockwise or counterclockwise.

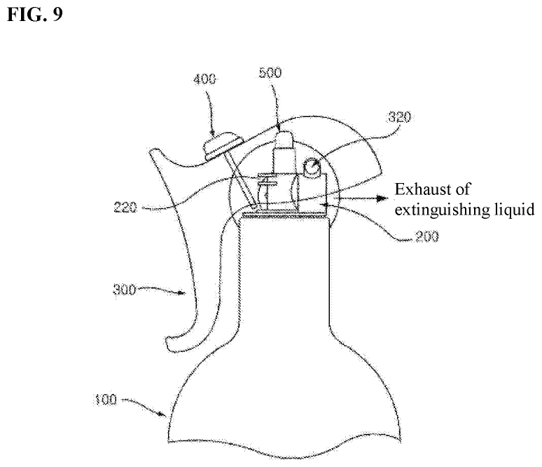

FIG. 9 is a nozzle open state diagram of the 2nd embodiment for the small fire extinguisher of this invention equipped with a rotary knob at the top. In FIG. 9, the 2nd embodiment of the small fire extinguisher of this invention equipped with a rotary knob at the top is comprised of a body part (100) that stores extinguishing liquid sprayed during fire, a nozzle part (200) that is attached to the top of the body part, has a valve at the inner center where compressed extinguishing liquid is sprayed through an opening part on one side by pressing a button part, and is comprised of a key insertion part (220) where an L-shaped key of a lock key can be inserted or removed on the other side of an L-shaped and round plate rotary knob attached to one side by a fixing pin (320), a button part (500) inserted and attached to the top of the nozzle part (200) so as to open and close the entry path of extinguishing liquid through the valve inside the nozzle part with the button (520) vertically entering in and coming out of the nozzle part according to rotation of the L-shaped and round plate rotary knob, an L-shaped and round plate rotary knob (300) that is attached to one side of the nozzle part (200) by a fixing pin (320), covers up one end of the nozzle part, contacts the top of the button part, and is attached with a locking part (400) at the top of the other side that controls rotation of the L-shaped and round plate rotary knob, and a locking part (400) attached to the top of the L-shaped and round plate rotary knob that stops or rotates the L-shaped and round plate rotary knob by inserting or removing a key (440) into or from the nozzle part as a key handle (420) is turned clockwise or counterclockwise. The small fire extinguisher of this invention equipped with a rotary knob at the top comprised of the exhausts extinguishing liquid in the body part (100) through the nozzle by opening the valve inside the nozzle part (200) when the lock key on the locking part (400) is rotated clockwise or counterclockwise to detach the key from the key insertion part (220), the L-shaped and round plate rotary knob (300) is rotated from top to bottom around the fixing pin (320), and the button (520) on the button part (500) is inserted into the nozzle part (200).

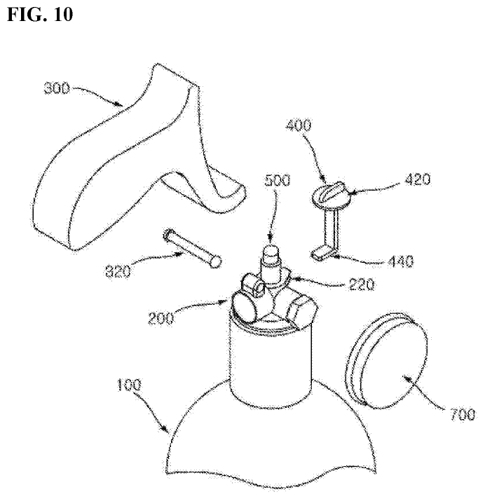

FIG. 10 is an exploded perspective diagram of the 2nd embodiment for small fire extinguisher of this invention equipped with a rotary knob at the top. In FIG. 10, the nozzle part (200) is comprised of the key insertion part (220) and the key (440) on the locking part (400) installed on the L-shaped and round plate rotary knob (300) is normally inserted into the key insertion part (220) to fix the L-shaped and round plate rotary knob (300) so as to prevent rotation. To use the fire extinguisher in case of fire, the plate rotary knob (300) can be rotated using the fixing pin (320) as the axis by rotating the rotary knob (420) on the locking part (400) clockwise or counterclockwise as the key (440) is detached from the key insertion part (220) of the nozzle part (200). When the L-shaped and round plate rotary knob (300) is rotated using the fixing pin (320) as the axis as described above, the L-shaped and round plate rotary knob (300) presses the button on the button part (500) at the top of the nozzle part. The button that moves vertically opens the valve inside the nozzle part, lifting one side of the L-shaped and round plate rotary knob (300) to exhaust extinguishing liquid to the front through the nozzle.

### INDUSTRIAL APPLICABILITY

The small fire extinguisher equipped with a rotary knob comprised of the above is small and convenient to use. It is appropriate for mobile places such as vehicles and can be furnished and used in partitioned places in offices and at home. This small fire extinguisher can be used effectively at actual fire scenes as it can be used easily by weak persons such as children and elders.

1. A small fire extinguisher equipped with a rotary knob that is installed inside a vehicle, house or office, comprising:
a body part (10) which stores loaded stream sprayed in case of fire;
a nozzle part (20) which is attached to a top of the body part, has a valve at an inner center where compressed loaded stream is sprayed through an opening part on one side by pressing a button part, and includes a key insertion part (22) where an L-shaped lock key is inserted or removed on another side of a round-shaped plate rotary knob attached to one side;
a button part (50) which is inserted and attached to a top of the nozzle part so as to open and close the valve with the button (52) vertically entering in and coming out of the nozzle part according to rotation of the plate rotary knob;
a plate rotary knob (30) which is attached to one side of the nozzle part by a fixing pin (32) and is attached with a lock key (40) that operates the button part; and
a lock key (40) which is attached to the plate rotary knob and stops or rotates the plate rotary knob by turning clockwise or counterclockwise.

2. The small fire extinguisher of claim 1, further comprising a pressure gauge which displays current pressure of loaded stream inside the body part.

3. The small fire extinguisher of claim 1, wherein the plate rotary knob (30) is a round-shaped plate that covers up one end of the nozzle part at a fixed distance and contacts the top of the button part.

4. The small fire extinguisher of claim 1, wherein the lock key (40) includes a key handle (42) to rotate the lock key and an L-shaped key (44) attached to the key handle.

5. A small fire extinguisher equipped with a rotary knob that is installed inside a vehicle, house or office, comprising:
a body part (100) which loads high-pressure extinguishing liquid;
a nozzle part (200) which is attached to a top of the body part that exhausts extinguishing liquid by opening and closing a valve;
an L-shaped and round plate rotary knob (300) which is attached to the nozzle part (200) and opens and closes the valve inside the nozzle part by operating a button part (500); and
a locking part (400) which is attached to a top of one side of the L-shaped and round plate rotary knob that makes a lock key removed from a key insertion part and stay away on one side by rotating the rotary knob (420) clockwise or counterclockwise.

6. The small fire extinguisher of claim 5, further comprising a pressure gauge (700) that displays current pressure of extinguishing liquid inside the body part.

7. The small fire extinguisher of claim 5, wherein the L-shaped and round plate rotary knob (300) is a round-shaped plate that rotates using the fixing pin (320) installed on the nozzle part as the axis, covers up one end of the nozzle part, and contacts the top of the button part.

8. The small fire extinguisher of claim 5, wherein the locking part (400) includes a key handle (420) to rotate the lock key and an L-shaped key (440) attached to the key handle.
